(19) United States
(12) Patent Application Publication
(10) Pub. No.: US 2014/0178809 A1
(43) Pub. Date: Jun. 26, 2014

(54) ELECTROPHOTOGRAPHIC PHOTORECEPTOR

(71) Applicant: Konica Minolta, Inc., Tokyo (JP)

(72) Inventors: Mayuko MATSUSAKI, Tokyo (JP); Tomoo SAKIMURA, Tokyo (JP); Shinichi HAMAGUCHI, Tokyo (JP); Hiroshi NAKAHARA, Tokyo (JP)

(73) Assignee: Konica Minolta, Inc., Tokyo (JP)

(21) Appl. No.: 14/091,567

(22) Filed: Nov. 27, 2013

(30) Foreign Application Priority Data
Dec. 26, 2012 (JP) 2012-283424

(51) Int. Cl. G03G 5/14

(52) U.S. Cl. CPC G03G 5/144
USPC 430/60

(57) ABSTRACT

According to the present invention, an electrophotographic photoreceptor comprising an intermediate layer is provided. The intermediate layer is a single layer and contains first metal oxide particles, second metal oxide particles having higher electron-transporting properties than those of the first metal oxide particle and a binder resin. The first metal oxide particles are unevenly distributed in the thickness direction of the intermediate layer.

### CROSS-REFERENCE TO RELATED APPLICATION

This application is based on Japanese Patent Application No. 2012-283424 filed on Dec. 26, 2012, the contents of which are incorporated herein by reference.

### BACKGROUND

1. Technical Field

This invention relates to an electrophotographic photoreceptor used in an electrophotographic image forming method. This invention relates particularly to an electrophotographic photoreceptor which reduces a defect of an image by provision of a specific intermediate layer between a conductive support and a photosensitive layer of the electrophotographic photoreceptor.

2. Description of Related Arts

Recently, an image forming apparatus such as electrophotographic copier and printer is required to achieve higher image quality. Examples of requirements to achieve high image quality include improvement of density unevenness in a page or between pages. In the image forming apparatus, as an image to be formed has a higher image quality and a higher resolution, the detectability is improved, then the density unevenness increasingly occurs. In order to improve the density unevenness, a variety of measures nave been taken in the image forming apparatus, and measures have been continuously examined.

In a negative electrification type electrophotographic photoreceptor with a laminate structure, which has been broadly used in recent years, an intermediate layer and a photosensitive layer composed of a charge transport layer on a charge generating layer are typically stacked on a conductive support. In such a negative electrification type electrophotographic photoreceptor with a laminate structure, when a surface thereof is negatively charged and then photographic exposed, charges are generated in the charge generating layer. Among the charges, negative charges (electrons) move to the conductive support through the intermediate layer. On the other hand, positive holes (holes) move to the electrophotographic photoreceptor surface through the charge transport layer and cancel the negative charges on the surface, and an electrostatic latent image is formed. Thus, the intermediate layer is required to have electron-transporting properties (to move rapidly the electrons, generated in the charge generating layer by exposure, to the conductive support) and hole blocking properties (to suppress injection of the positive holes from the conductive support to the photosensitive layer).

As a conventional attempt to improve image defects such as density unevenness and fog and enhance a stability in a low-temperature environment and repetition stability, an electrophotographic photoreceptor using a specific titanium oxide powder in an undercoating layer of the electrophotographic photoreceptor has been known (Patent Literature 1). Patent Literature 1 discloses two or more kinds of undercoating layers having different sizes and containing needle-like titanium oxide having a specific physical property. According to the description of Patent Literature 1, when the elongated needle-like titanium oxide is used in the undercoating layer, titanium oxide particles are easily in contact with each other, so that a contact area is increased; therefore, the sensitivity of the photoreceptor, a residual potential, and so on can be.

As a method of improving the above-mentioned density unevenness, it is considered to simply enhance the electron-transporting properties of the intermediate layer. However, when the electron-transporting properties are merely enhanced, the injection of the positive holes into the photosensitive layer from the conductive support cannot be satisfactorily suppressed. Namely, enough hole blocking properties cannot be obtained. When a highly sensitive charge generating material is used as a charge generating material contained in the charge generating layer, leakage of carriers generated by thermal excitation occurs and thereby partially reduces a surface potential of the electrophotographic photoreceptor, and there is a problem that image defects such as black spots and fog occur.

In this context, in the prior art described in Patent Literature 1, the image defects such as density unevenness cannot be satisfactorily suppressed in a recent image forming apparatus with an improved detectability. In particular, when the highly sensitive charge generating material is used in the charge generating layer, injection of irregular electrons cannot be satisfactorily suppressed, and it was found that the image defects such as black spots and fog easily occurred.

Patent Literature 1: Japanese Laid-open Patent Publication No. 2008-096664

### SUMMARY

In view of the above circumstances, the object of this invention is to provide an electrophotographic photoreceptor, which can suppress density unevenness in an image to be formed and suppress image defects such as black spots and fog, and an image forcing apparatus.

The above object of the invention can be achieved by the following constitutions.

To achieve at least one of the above-mentioned objects, an electrophotographic photoreceptor comprises an intermediate layer being a single layer,

wherein said intermediate layer contains first metal oxide particles, second metal oxide particles having higher electron-transporting properties than those of the first metal oxide particle and a binder resin, and

the first metal oxide particles are unevenly distributed in a thickness direction of the intermediate layer.

In the above described electrophotographic photoconductor, the first metal oxide particles are unevenly distributed in a thickness direction of the intermediate layer so as to satisfy the following relationship:

Vₐ/V₁≧0.5,

V_{b}/V₁≧0.5,

or

V_{c}/V₁≧0.5,

wherein, when a cross section of the intermediate layer is equally divided into three layers in a thickness direction, V₁ is a total volume of the first metal oxide particles in the intermediate layer, Vₐ is a volume of the first metal oxide particles in a outermost layer of the divided intermediate layers, V_{b} is a volume of the first metal oxide particles in a middle layer of the divided intermediate layers, and V_{c} is an innermost layer of the divided intermediate layers.

### BRIEF DESCRIPTION OF THE DRAWINGS

FIG. 1 is a schematic cross-sectional view showing an example of a layer constitution of an electrophotographic photoreceptor of the invention;

FIG. 2 is a schematic diagram showing a cross section of an intermediate layer of the electrophotographic photoreceptor of the invention;

FIG. 3 is a schematic cross-sectional view showing an embodiment of an image forming apparatus of the invention; and

FIG. 4 is a view showing a chart for image evaluation in the Examples.

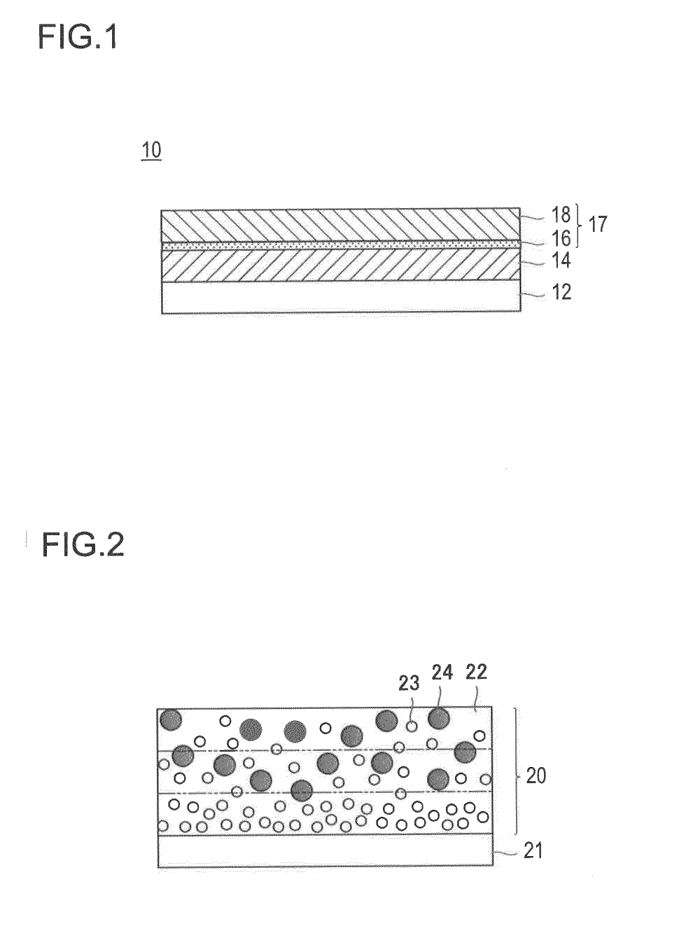

In the FIGS. 1 to 4, symbol 10, 111Y, 111M, 111C and 111Bk stands for electrophotographic photoreceptor, 12 and 21 for conductive support, 14 and 20 for intermediate layer, 16 for electric charge generating layer, 17 for photosensitive layer, 18 for charge transport layer, 22 for binder resin, 23 for first metal oxide particle, 24 for second metal oxide particle, 100 for an image forming apparatus, 110Y, 110M, 110C and 110Bk for image forming unit, 113Y, 113M, 113C and 113Bk for charging means, 115Y, 115M, 115C and 115Bk for exposure means, 117Y, 117M, 117C and 117Bk for developing means, 119Y, 119M, 119C, 119Bk and 135 for cleaning means, 130 for endless belt-like intermediate transfer body unit, 131 for endless belt-like intermediate transfer body, 133Y, 133M, 133C and 133Bk for primary transfer roller (transfer means), 137A, 137B, 137C and 137D for roller, 150 for paper feeding and conveying means, 170 for fixing means, 200 for process cartridge, 201 for housing, 203R and 203L for support rail, 211 for paper feeding cassette, 213A, 213B, 213C and 213D for intermediate roller, 215 for resist roller, 217 for secondary transfer roller (transfer means), 219 for paper discharge roller, 221 for paper discharge tray, D for rotation axis direction of the electrophotographic photoreceptor, P for transfer material, SC for image reading device.

### DETAILED DESCRIPTION

Hereinafter, this invention will be described in detail.

<Constitution of Electrophotographic Photoreceptor>

(Layer Constitution of Electrophotographic Photoreceptor)

An electrophotographic photoreceptor (hereinafter also referred to simply as a photoreceptor) of this invention is a negative electrification type electrophotographic photoreceptor and has an intermediate layer on a conductive support, and the electrophotographic photoreceptor is formed by stacking a photosensitive layer on the intermediate layer.

In the electrophotographic photoreceptor of the invention, the photosensitive layer has a function of generating charges by exposure and a function of transporting the generated charges (positive holes) to a photoreceptor surface. The photosensitive layer may have a single layer structure in which the charge generating function and the charge transporting function are performed in the same layer or may have a laminate structure in which the charge generating function and the charge transporting function are performed in different layers. However, in order to suppress an increase of a residual potential due to repeated use, the electrophotographic photoreceptor preferably has a laminate structure including a charge generating layer and a charge transport layer. The electrophotographic photoreceptor of the invention may further have a protective layer formed on the photosensitive layer.

Although the layer constitution of the electrophotographic photoreceptor of the invention is not limited particularly, specific examples of the layer constitution include the following layer constitutions (1) and (2). Namely, (1) a layer constitution in which an intermediate layer is provided on a conductive support, a photosensitive layer of a laminate structure including a charge generating layer containing a charge generating material and a charge transport layer containing a charge transport material stacked in this order is stacked on the intermediate layer, and the charge transport layer is an outermost surface layer, and (2) a layer constitution in which an intermediate layer is provided on a conductive support, a photosensitive layer containing the charge generating material and the charge transport material and having a single layer structure is stacked on the intermediate layer, and the photosensitive layer (single layer) is an outermost surface layer.

In this invention, the electrophotographic photoreceptor is preferably configured with an organic compound which functions at least one of the charge generating and the charge transporting essential for a constitution of the electrophotographic photoreceptor. The electrophotographic photoreceptor of this invention can include all known electrophotographic photoreceptors such as a photoreceptor having a photosensitive layer constituted of a known organic charge generating material or organic charge transport material and a photoreceptor having a photosensitive layer in which the charge generating function and the charge transport function are constituted of a polymer complex.

Hereinafter, the case in which the electrophotographic photoreceptor of the invention has the preferred layer constitution (1) will be specifically described.

FIG. 1 is a schematic cross-sectional view showing an example of a layer constitution of the electrophotographic photoreceptor of this invention.

An electrophotographic photoreceptor 10 includes a photosensitive layer 17 formed by stacking a charge generating layer 16 and a charge transport layer 18 in this order on a conductive support 12 via an intermediate layer 14.

In the electrophotographic photoreceptor 10, when a surface of the electrophotographic photoreceptor 10 is negatively charged and thereafter photographic exposed, charges are generated in the charge generating layer 16. Among the charges generated in the charge generating layer 16, negative charges (electrons) move to the conductive support 12 through the intermediate layer 14, and the positive holes move to a surface of the electrophotographic photoreceptor 10 through the charge transport layer 18 and cancels the negative charges on the surface of the electrophotographic photoreceptor 10, whereby an electrostatic latent image is formed on the surface of the electrophotographic photoreceptor 10.

In this invention, although not illustrated, two kinds of metal oxide particles having different functions, first metal oxide particles used mainly for blocking irregular electrons and second metal oxide particles used mainly for enhancing the electron-transporting properties are included in the intermediate layer 14. The first metal oxide particles are characterized by being unevenly distributed in the film thickness direction of the intermediate layer. According to this constitution, in the intermediate layer, the electron-transporting properties are secured, injection of both the irregular electrons and the positive holes can be suppressed. Thereby, occurrence of image unevenness can be suppressed, and, at the same time, occurrence of image defects such as black spots and fog can be suppressed.

In an electrophotographic photoreceptor of this invention, the two kinds of metal oxide particles having different functions are contained in the intermediate layer, and first metal oxide particles are unevenly distributed in a thickness direction of the intermediate layer, whereby density unevenness of an image to be formed can be suppressed, and, at the same time, image defects such as black spots and fog can be suppressed. According to the electrophotographic photoreceptor of this invention, even when a highly sensitive material is particularly used as a charge generating material, the density unevenness and the image defects of an image to be obtained can be effectively suppressed.

Next, in the conductive support constituting the photoreceptor of this invention, the intermediate layer, and the photosensitive layer including the charge generating layer and the charge transport layer, members constituting each layer will be described.

<Conductive Support>

As the conductive support constituting the electrophotographic photoreceptor of this invention, any electrophotographic photoreceptor having a cylindrical or sheet-like shape and having a conductivity may be used. For example, there are available a conductive support obtained by molding metal, such as aluminum, copper, chrome, nickel, zinc, and stainless steel, in the form of a drum or a sheet, a conductive support obtained by laminating a metal foil of aluminum, copper, or the like on a plastic film, a conductive support obtained by depositing aluminum, indium oxide, tin oxide, or the like on a plastic film, and a metal, a plastic film and a paper in which a conductive layer is provided by coating a conductive material singly or with a binder resin.

<Intermediate Layer>

In the electrophotographic photoreceptor of this invention, an intermediate layer in contact with the conductive support and the photosensitive layer is provided between the conductive support and the photosensitive layer. The intermediate layer contains first metal oxide particles having a high function of blocking the irregular electrons and the positive electrons and second metal oxide particles used for enhancing the electron-transporting properties, and a binder resin. The first metal oxide particles are unevenly distributed in the film-thickness direction of the intermediate layer.

The state in which the first metal oxide particles are unevenly distributed in the film-thickness direction of the intermediate layer is a state in which a cross section of the intermediate layer is observed, and when the thickness of the intermediate layer is equally divided into three layers from the surface side, there is a layer that the proportion of the first metal oxide particles is not less than 1.5 times the average of the proportion of the first metal oxide particles in the entire intermediate layer. Namely, the state in which the first metal oxide particles are unevenly distributed in the film-thickness direction of the intermediate layer is a state in which any one of the three equally divided layers contains the first metal oxide particles in an amount of not less than 50% relative to the total amount of the first metal oxide particles. In other words, a portion in which the concentration of the first metal oxide particle is high exists as a layer in the intermediate layer, and namely the first metal oxide particles are unevenly distributed in the intermediate layer. According to this constitution, the charge injection from the charge generating layer and the conductive support can be suppressed while maintaining high electron-transporting properties, and the concentration unevenness can be suppressed. At the same time, the image defects such as black spots and fog can be suppressed.

FIG. 2 is a cross-sectional view schematically showing an example of a state in which the first metal oxide particles are unevenly distributed in the intermediate layer. As shown in FIG. 2, on a conductive support 21, first metal oxide particles 23 and second metal oxide particles 24 are herd in an intermediate layer 20 by a binder resin 22. When the intermediate layer 20 is equally divided into three layers in the thickness direction as shown by the dashed lines, approximately half of the whole amount of the first metal oxide particles 23 exist in a layer closest to the substrate in this case. The first metal oxide particles 23 are unevenly distributed in a region at the substrate side, whereby the majority of the second metal oxide particles 24 exist in the remaining layers.

The above state can be represented by the following formulae, namely, the first metal oxide particles are unevenly distributed in the thickness direction of the intermediate layer so as to satisfy the following relationship:

Vₐ/V₁≧0.5,

V_{b}/V₁≧0.5,

or

V_{c}/V₁≧0.5.

In the formulae, when a cross section of the intermediate layer is equally divided into three layers in the thickness direction, V₁ is the total volume of the first metal oxide particles in the intermediate layer, Vₐ is a volume of the first metal oxide particles in a outermost layer of the divided intermediate layers, V_{b} is a volume of the first metal oxide particles in a middle layer of the divided intermediate layers, and V_{c} is an innermost layer of the divided intermediate layers. In order to achieve a desired effect of the invention, it is more preferably 0.9≧Vₐ/V₁≧0.6, 0.9≧V_{b}/V₁≧0.6, or 0.9≧V_{c}/V₁≧0.6.

Whether the first metal oxide particles are unevenly distributed in the film-thickness direction of the intermediate layer can be confirmed by, for example, observation of the cross section in the thickness direction at an arbitrary portion of the intermediate layer by means of TEM of 50,000 to 200,000 magnifications. When the cross section is observed, a region where the first metal oxide particles are rich can be confirmed, and namely, a state defined by the above in which the first metal oxide particles are unevenly distributed can be observed. The unevenly distribution of the first metal oxide particles can also be confirmed by ESCA measurement after etching the intermediate layer in the thickness direction and cross-sectional observation using ICP.

In this invention, the first metal oxide particle mainly serves to suppress the injection of the irregular electrons from the charge generating layer, the injection, of the positive holes from the conductor support, and the movement of the irregular electrons injected in the intermediate layer, that is, block the irregular electrons and the positive holes. Accordingly, the first metal oxide particle can fulfill the function if the first metal oxide particles exist thinly in the intermediate layer, and the image defects such as black spots and fog can be suppressed. Meanwhile, the second metal oxide particle has higher electron-transporting properties than those of the first metal oxide particle and mainly contributes to the enhancement of the electron-transporting properties. Accordingly, the image unevenness can be effectively suppressed by the existence of the second metal oxide particles.

In this invention, the intermediate layer contains the first metal oxide particles and the second metal oxide particles, whereby the image defects such as black spots and fog can be effectively suppressed, and, at the same time, the density unevenness can be suppressed. The first metal oxide particle having a higher function of blocking the irregular electrons than that of the second metal oxide particle is used, and the second metal oxide particle having a higher function of enhancing the electron-transporting properties than those of the first metal oxide particle is used. Accordingly, the first metal oxide particle may have not only the function of blocking the irregular electrons but also the function of enhancing the electron-transporting properties, that is, the function of the second metal oxide particle, and may have any other functions. Meanwhile, the second metal oxide particle not only achieves the function of enhancing the electron-transporting properties but also may have the function of blocking the irregular electrons, that is, the function of the first metal oxide particle, and may have any other functions.

In order to evaluate the electron-transporting properties of the first and second metal oxide particles, the following method can be used. Namely, a film simulating an intermediate layer of a photoreceptor is formed using one kind for each metal oxide particle. Next, a constant voltage is applied to the film and the film electrically charged, and a surface potential is measured. After that, the application of the voltage is interrupted, and time change of reduction in the potential of the film is measured. It can be said that as an absolute value of the surface potential is smaller (a difference between the absolute value and the applied voltage becomes large) and the reduction in the potential is faster, the electron-transporting properties are high. Then, the particle having higher electron-transporting properties can be used as the second metal, oxide particle. A metal oxide particle having lower electron-transporting properties often has a higher function of blocking the movement of the irregular electrons. By using such a method, a combination of the first and second metal oxide particles can be selected. Further, finally, whether the first and second metal oxide particles fulfill their functions can be confirmed by whether the image defect such as black spots and fog and the density unevenness in an obtained image are reduced in comparison to the prior art when a photoreceptor is constituted using these metal oxide particles.

Although details of the materials of the first and second metal oxide particles will be described later If the first and second metal oxide particles can fulfill their functions, particles subjected to different surface treatment for the same material and particles formed of the same material and having different particle sizes can be used, for example.

According to the electrophotographic photoreceptor of this invention, when a particularly highly sensitive charge generating material is used as the charge generating material in the charge generating layer, it is possible to suppress the image defects such as black spots and fog due to leakage of carriers generated by thermal excitation and so on other than exposure.

A ratio (volume ratio) of the first metal oxide particle and the second metal oxide particle is preferably 6:4 to 3:7, although depending on the kinds of the particles to be used. When the ratio of the first metal oxide particle is not more than 6:4, the movement of the charges is less likely to be prevented, then the density unevenness can be more effectively prevented. When the ratio of the first metal oxide particle is not less than 7:3, the movement of the irregular electrons in the intermediate layer can be more reliably prevented, and therefore, the image defects including fog and black spots can be more reliably suppressed. In this case, since the first metal oxide particles contributed to the blocking properties of the irregular electrons may thinly exist in the intermediate layer, the amount of the first metal oxide particles is preferably smaller than the amount of the second metal oxide particles contributing to the enhancement of the electron-transporting properties of the entire intermediate layer.

In this invention, the intermediate layer is a single layer. To be a single layer means a state in which a binder resin constituting the intermediate layer is uniform in the thickness direction, and an interface of the binder resin does not exist in the intermediate layer. This is because, when the intermediate layer is a single layer, the ratio of the second metal oxide particle is continuously changed, and therefore, the electron-transporting properties is high, and, at the same time, the electron-transporting properties are not interfered by an interface. When the intermediate layer is a single layer, the intermediate layer can be formed at one time by coating with a coating liquid containing both the first and second metal oxide particles, and therefore, since the process is simple, it is preferable.

Since the kind of a metal oxide particle having the function of the first metal oxide particle or the function of the second metal oxide particle is depended on the particle size, the kind of surface treatment, the thickness of surface treatment, and the crystal form of the particle, it cannot be specifically and categorically described. As a tendency, as the particle since of the metal oxide particle decreases, the particle more easily contributes to the enhancement of the electron-transporting properties, and as the particle size of the metal oxide particle increases, the particle more easily contributes to the enhancement of the blocking properties of the irregular electrons. As the surface treatment, when both silica-alumina treatments are applied, the particle is easily the particle contributing to the enhancement of the blocking properties of the irregular electrons. Also, when the surface treatment amount is large and the thickness of the surface treatment is large, the particle is easily the particle contributing to the enhancement of the blocking properties of the irregular electrons. When the metal oxide particle is oxide titanium, as the crystal form, is an anatase type, high electron-transporting properties tend to be exhibited.

Examples of the first metal oxide particle and second metal oxide particle include metal oxide particles such as titanium oxide, zinc oxide, alumina (aluminum oxide), tin oxide, antimony oxide, indium oxide, bismuth oxide, and zirconium oxide and fine particles such as indium oxide doped with zinc, zinc oxide doped with antimony, and zirconium oxide doped with antimony. Among those particles, as the first metal oxide particle and second metal oxide particle, titanium oxide and zinc oxide are preferable, and rutile type titanium oxide is more preferable. In one embodiment of the invention, at least the first metal oxide particle is a titanium oxide particle. In an embodiment, the first metal oxide particle and the second metal oxide particle are a titanium oxide particle.

For the first metal oxide particles and second metal oxide particles, a number average primary particle size is preferably 1 to 100 nm. For the first metal oxide particles and second metal oxide particles, a number average primary particle size is more preferably 5 to 95 nm. When the number average primary particle size of the metal oxide particle is in the above range, the electron-transporting properties are preferable, and dispersibility is not damaged. Therefore, the image defects such as black spots and fog can be suppressed, and, at the same time, the density unevenness can be satisfactorily suppressed.

In this invention, the number average primary particle sizes of the first and second metal oxide particles are measured as follows. Namely, a TEM (transmission electron microscope) image of the metal oxide particle is observed with a magnification of 100000 times, and 100 particles are randomly selected as primary particles. A horizontal Feret diameter of those primary particles is measured by image analysis, and the average value of them is obtained as “number average primary particle size”.

The first metal oxide particles and second metal oxide particles are preferably subjected to surface treatment by a surface treatment agent. Examples of the surface treatment agent include an inorganic compound and an organic compound, and examples of the organic compound include a reactive organic silicone compound, and an organic titanium compound. These surface treatment agents may be used alone, or two or more kinds of them may be used. Namely, it is preferable that at least one of the first metal oxide particle and the second metal oxide particle was surface treated by at least one of an inorganic compound, a reactive organic silicone compound and an organic titanium compound.

Examples of the inorganic compound include alumina, silica, zirconia, and a hydrate thereof. Among those inorganic compounds, alumina, silica, and a combination of alumina and silica are particularly preferred because a hydrophobicity degree of the metal oxide particle is easily controlled. Those inorganic compounds may be used singly, or two or more kinds of them may be used in combination. In one embodiment of this invention, the inorganic compound is alumina, silica, or a combination of alumina and silica. As the metal oxide particles subjected to the surface treatment with the inorganic compound, a commercial product such as an oxide titanium particles treated by silica-alumina may be used. Examples of commercial products include F-1S02 (manufactured by Showa Denko K.K.), T-805 (manufactured by Japan Aerosil Co., Ltd.), STT-30A and STT-65S-S (manufactured by Titan Kogyo, Ltd.), TAF-500T and TAF-1500T (manufactured by Fuji Titanium Industry Co., Ltd.), MT-100S, MT-100T, MT-500SA, MT-100SA (manufactured by Tayca Corporation), and IT-S (manufactured by Ishihara Sangyo Kaisha, Ltd.).

Examples of the reactive organic silicon compound include alkoxysilane such as methyl trimethoxysilane, n-butyl trimethoxy silane, n-hexyl trimethoxy silane, dimethyldimethoxysilane, 3-methacryloxypropyl methyl diethoxysilane, 3-methacryloxypropyl trimethoxy silane, 3-methacryloxypropyl triethoxy silane, 3-acryloxypropyl trimethoxysilane, 3-acryloxypropyl triethoxysilane, 2-methacryloxyethyl trimethoxy silane, and 3-methacryloxy butyl methyldimethoxy silane; hexamethyldisilazane, and a polysiloxane compound such as methyl hydrogen polysiloxane. Among those, 3-methacryloxypropyl trimethoxy silane, 3-acryloxypropyl trimethoxy silane, and methyl hydrogen polysiloxane are particularly preferred because the hydrophobicity degree of the metal oxide particle is easily controlled. In one embodiment of the invention, the reactive organic silicone compound is at least one of 3-methacryloxypropyl trimethoxy silane, 3-acryloxypropyl trimethoxysilane, and methyl hydrogen polysiloxane.

Examples of the organic titanium compound include alkoxy titanium (that is, titanium alkoxide), titanium polymer, titanium acylate, titanium chelate, tetrabutyl titanate, tetraoctyl titanate, isopropyl isostearoyl titanate, isopropyl tridecyl benzenesulfonyl titanate, and bis (dioctylpyrophosphate) oxyacetate titanate. Among those, titanium acylate and titanium chelate are particularly preferred. In an embodiment of the invention, the organic titanium compound is at least one of titanium acylate, titanium chelate.

The surface treatment applied to the metal oxide particle with the surface treatment agent can be performed by a publicly known method. The method is not limited particularly, and wet treatment or dry treatment can be adopted. In the dry treatment, the metal oxide particles are dispersed in the form of a cloud by agitation, for example, and a hydrophobic treatment agent solution dissolved with alcohol or the like is sprayed to the obtained dispersion, or a vaporised hydrophobic treatment agent is brought into contact with the dispersion, whereby the hydrophobic treatment agent can be adhered. In a surface treatment method using the wet treatment, the metal oxide particles are added to a solution prepared by dispersing a surface treatment agent in water or an organic solvent, and the solution is mixed and stirred. Alternatively, the metal oxide particles are dispersed in a solution, and a hydrophobic treatment agent is dropped in the obtained dispersion and adhered to the metal oxide particles. In the wet treatment, wet cracking may be performed by a bead mill or the like. After that, an obtained solution is filtered and dried, and obtained metal oxide particles are subjected to annealing (baking), whereby the wet treatment can be performed.

A temperature at the time of mixing and stirring in the wet treatment is preferably approximately 25 to 150° C. more preferably 30 to 60° C. The mixing and stirring time is preferably 0.1 to 10 hours, more preferably 0.2 to 5 hours. The annealing treatment temperature may be for example 100 to 220° C., preferably 110 to 150° C. The annealing treatment time is preferably 0.5 to 10 hours, more preferably 1 to 5 hours. A treatment temperature in the wet cracking is preferably 20 to 50° C., more preferably 30 to 40° C. The time in the wet cracking is preferably 10 to 120 minutes, more preferably 20 to 70 minutes.

In the wet surface treatment method, since the usage of the surface treatment agent is different depending on the object and the kind of the surface treatment agent, it cannot be categorically determined, and it is preferable that the surface treatment is performed while suitably selecting the usage of the surface treatment agent. For example, a reactive organic silicon compound may be used in an amount of preferably 0.1 to 20 parts by mass, more preferably 1 to 15 parts by mass, based on 100 parts by mass of untreated metal oxide particles. For example, organic titanium compound may be used in an amount of preferably 0.1 to 20 parts by mass, more preferably 2 to 15 parts by mass, based on 100 parts by mass of untreated metal oxide particles. The additive amount of a solvent is preferably 100 to 600 parts by mass, more preferably 200 to 500 parts by mass, based on 100 parts by mass of untreated metal oxide particles.

When the usage of the surface treatment agent is not less than the above lower limit value, the surface treatment can be satisfactorily applied to untreated metal oxide particles. Meanwhile, when the usage of the surface treatment agent is not more than the above upper limit value, it is prevented that the surface treatment agents are reacted with each other, whereby a uniform coat is not adhered to the surface of the metal oxide particle, and leakage can occur easily.

For the electrophotographic photoreceptor of this invention, particles other than the first and second metal oxide particles may be contained in an intermediate layer as long as it does not interfere with the uneven distribution of the first metal oxide particles. Examples of other particles include particles serving to assist the electron-transporting properties and particles used for controlling surface roughness. More specifically, other particles can be suitably selected from among the above metal oxide particles, silica, and so on.

(Binder Resin)

Examples of a binder resin constituting the intermediate layer (hereinafter also referred to as a binder resin for intermediate layer) include polyamide resin, vinyl chloride resin, vinyl acetate resin, casein, polyvinyl alcohol resin, polyurethane resin, nitrocellulose, ethylene/acrylic acid copolymer, and gelatin. Among those binder resins, polyamide resin is preferable because dissolution of an intermediate layer is suppressed when a coating liquid used for forming a charge generating layer to be described later is coated on the intermediate layer. It is preferably an alcohol-soluble polyamide resin such as methoxy methylolated polyamide resin because the above surface-treated metal oxide particle is preferably dispersed in an alcohol-based solvent. In an embodiment, the binder resin is polyamide resin. In an embodiment, the polyamide resin is alcohol-soluble polyamide resin.

The film thickness of the intermediate layer is preferably 0.5 to 15 μm, more preferably 1 to 7 μm. When the film thickness of the intermediate layer is not less than 0.5 μm, the entire surface of the conductive support can be reliably covered, and the injection of the positive holes from the conductive support can be satisfactorily blocked, then the image defeats such as black spots and fog can be satisfactorily suppressed. Meanwhile, when the film thickness of the intermediate layer is not more than 15 μm, electrical resistance is small, and sufficient electron-transporting properties are obtained, whereby the density unevenness can be satisfactorily suppressed.

<Photosensitive Layer>

The photosensitive layer constituting the photoreceptor of this invention preferably may have a single layer structure in which the charge generating function and the charge transporting function are imparted to a single layer, more preferably has a layer constitution in which the functions of the photosensitive layer are separated into a charge generating layer (CGL) and a charge transport layer (CTL). When the function separation type layer constitution is applied as above, the rise of residual potential due to repeated use can be controlled to low level, and, in addition, there is a merit that various electrophotographic characteristics are easily controlled according to purposes. A negative charged photoreceptor is configured that the charge generating layer is provided on the intermediate layer, and the charge transport layer is provided on the charge generating layer. A positive charged photoreceptor is configured that the charge transport layer is provided on the intermediate layer, and the charge generating layer is provided on the charge transport layer. A preferable layer constitution of the photosensitive layer is the negative charged photoreceptor having the above function separation structure.

Hereinafter, as preferable specific examples of the photosensitive layer, a photosensitive layer of the function separation type negative charged photoreceptor, that is, a photosensitive layer in which the charge generating layer and the charge transport layer are stacked will be described.

(Charge Generating Layer)

The charge generating layer formed in this invention preferably contains a charge generating material and a binder resin for charge generating layer. Further, the charge generating layer is preferably formed by being coated with a coating liquid prepared by dispersing the charge generating material in a binder resin solution.

Examples of the charge generating material include azo pigments such as Sudan Red and Dian Blue, quinone pigments such as pyrene quinone and anthanthorone, quinocyanine pigments; perylene pigments, indigo pigments seen as indigo and thioindigo, and phthalocyanine pigments, and the charge generating material is not limited to those. Preferred are titanylphthalocyanine pigments. Those charge generating materials may be used singly, or two or more kinds of them may be used in combination.

The charge generating material may be selected from the above charge generating materials according to the sensitivity for oscillation wavelength of the exposure light source. In order to enhance the sensitivity for the oscillation wavelength of an exposure light source in a digital copier, a phthalocyanine pigment is preferably used. In order to enhance the sensitivity for the oscillation wavelength of the exposure light source, for example, a wavelength of 780 nm, there is preferably used a Y-type titanyl phthalocyanine pigment or a mixture of a titanyl phthalocyanine pigment and a butanediol-added titanyl phthalocyanine pigment, particularly a 2,3-butanediol-added titanyl phthalocyanine pigment with. Those phthalocyanine pigments are contained in a highly-sensitive charge generating material.

Y-type phthalocyanine has a maximum diffraction peak at a Bragg angle of (2θ±0.2°) 27.3° in an X-ray diffraction spectrum obtained by Cu—Kα characteristic X-ray.

Examples of titanyl phthalocyanine with butanediol include 2,3-butanediol-added titanyl phthalocyanine. The structure of the 2,3-butanediol-added titanyl phthalocyanine is schematically shown by the following formula (1).

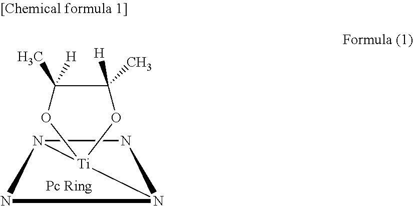

2,3-butanediol-added titanyl phthalocyanine may have a different crystal form depending on a ratio of butanediol to be added. In order to obtain good sensitivity, preferred is 2,3-butanediol-added titanyl phthalocyanine having a crystal form obtained by a reaction so that a butanediol compound is not more than 1 mol with respect to 1 mol of titanyl phthalocyanine, 2,3-butanediol-added titanyl phthalocyanine having such a crystal form has a characteristic peak at least a Bragg angle (2θ±0.2°) 8.3° in an X-ray powder diffraction spectrum. The titanyl phthalocyanine with 2,3-butanediol has peaks at 24.7°, 25.1°, and 26.5° other than 8.3°.

Butanediol-added titanyl phthalocyanine may be contained singly or contained with a titanyl phthalocyanine which isn't added with butanediol.

As the charge generating material, a mixture of 2.3-butanediol-added titanyl phthalocyanine and a titanyl phthalocyanine which is not added with butanediol may be used. An absorbance ratio (Abs(780)/Abs(700)) of an absorbance Abs(780) at a wavelength of 780 nm of the photosensitive layer and an absorbance Abs (700) at a wavelength of 700 nm is preferably 0.8 to 1.1, and the absorbance ratio is obtained by conversion from a relative reflectance spectrum of an electrophotographic photoreceptor including a photosensitive layer (charge generating layer) containing that mixture.

The absorbance ratio (Abs(780)/Abs(700)) can be obtained as follows.

(1) First, a photoreceptor sample in which a photosensitive layer containing a mixture of 2,3-butanediol-added titanyl phthalocyanine and a titanyl phthalocyanine which is not added with butanediol is formed on an aluminum support is provided. Then, the absorption spectrum of relative reflected light of the photoreceptor sample is measured. The absorption spectrum of the reflected light can be measured by using an optical film thickness measuring device “Solid Lambda Thickness” (manufactured by Spectra Co-op).

Namely, a reflection intensity of the aluminum support at each wavelength is first measured as a base line. Subsequently, the reflection intensity of the photoreceptor sample at each wavelength is measured. Then, a value obtained by dividing the reflection intensity of the photoreceptor sample at each wavelength by the reflection intensity of the aluminum support at each wavelength is a “relative reflectance (R_{λ})”. Consequently, the relative reflectance spectrum is obtained.

(2) Then, the obtained relative reflectance spectrum of the photoreceptor sample is converted into the absorbance spectrum by the following formula (A).

Formula (A): Absλ=−log(R_{λ}) [in the formula (A), R_{λ} represents the relative reflectance obtained by dividing the reflection intensity of the photoreceptor sample at the wavelength λ by the reflection intensity of the aluminum support at the wavelength λ.]

(3) Subsequently, in order to remove irregularities due to interference fringes, absorbance spectrum data converted by the formula (2) is approximated to a secondary polynomial expression in a wavelength region of 765 to 795 nm and a wavelength region of 635 to 715 nm.

(4) Then, the absorbance Abs (780) at a wavelength of 780 nm and the absorbance Abs (700) at a wavelength of 700 nm in the approximated secondary polynomial expression are obtained. Consequently, the absorbance ratio (Abs (780)/Abs (700)) is calculated,

In butanediol-added titanyl phthalocyanine with, the absorbance ratio (Abs(780)/Abs(700)) of the absorbance Abs(780) at a wavelength of 780 nm of the photosensitive layer and the absorbance Abs (700) at a wavelength of 700 nm is preferably 0.8 to 1.1, and the absorbance ratio is obtained by conversion from the relative reflectance spectrum of the electrophotographic photoreceptor including the photosensitive layer (charge generating layer) containing butanediol-added titanyl phthalocyanine. When the absorbance ratio (Abs(780)/Abs(700)) of the photosensitive layer containing titanyl phthalocyanine with butanediol is in the above range, pigment crystal is easily stabilized by proper dispersion share, and photosensitivity and image characteristics by repeated light exposure are stabilized.

The absorbance ratio of the photosensitive layer containing butanediol-added titanyl phthalocyanine can be measured in the same manner as above.

(Binder Resin for Charge Generating Layer)

As the binder resin for charge generating layer, known resin can be used, and examples of the binder resin for charge generating layer include a polystyrene resin, a polyethylene resin, a polypropylene resin, an acrylic resin. a methacrylic resin, a vinyl chloride resin, a vinyl acetate resin, a polyvinyl butyral resin, an epoxy resin, a polyurethane resin, a phenol resin, a polyester resin, an alkyd resin, a polycarbonate resin, a silicone resin, a melamine resin, a copolymer containing at least two of these resins (for example, a vinyl chloride-vinyl acetate copolymer resin, and a vinyl chloride-vinyl acetate-anhydrous maleic acid copolymer resin), and a polyvinyl carbazole resin, but the binder resin is not limited to those. A polyvinyl butyral resin is preferable. A weight-average molecular weight of the binder resin is not limited particularly, and it is preferably 10000 to 150000, more preferably 15000 to 100000.

As a mixing ratio of the charge generating material to the binder resin for charge generating layer, the amount of the charge generating material is preferably 20 to 600 parts by mass, more preferably 50 to 500 parts by mass, based on 100 parts by mass of the binder resin for charge generating layer. When the content of the charge generating material is in the above range, a sufficient charge can be generated by exposure, sufficient sensitivity of the photosensitive layer (charge generating layer) can be secured, and, at the same time, the residual potential can be prevented from being increased by repetition use.

The film thickness of the charge generating layer is different depending on the characteristics of the charge generating material and the characteristics and the mixture ratio of the binder resin, and the film thickness is preferably 0.01 to 5 μm, more preferably 0.05 to 3 μm.

(Charge Transport Layer)

The charge transport layer formed in this invention is preferably constituted by containing a charge (positive hole) transport material and a binder resin for charge transport layer. The charge transport layer is preferably formed by being coated with a solution prepared by dissolving the charge transport material in a binder resin solution.

A known compound can be used as the charge transport material, and the following compounds can be used, for example. Namely, a triarylamine derivative, a hydrazone compound, a styryl compound, a benzidine compound, at butadiene compound, a carbazole derivative, an oxadiazole derivative, a thiazole derivative, a thiadiazole derivative, a triazole derivative, an imidazole derivative, an imidazolone derivative, an imidazolidine derivative, a bisimidazolidine derivative, a pyrazoline compound, an oxazolone derivative, a benzimidazole derivative, a quinazoline derivative, a benzofuran derivative, an acrydine derivative, a phenadine derivative, an aminostilbene derivative, a phenylenediamine derivative, a stilbene derivative, poly-N-vinylcarbazole, poly-1-vinylpyrene, and poly-9-vinylanthracene. Those compounds may be used alone or may be used by mixing two or more kinds of them. Among them, a triarylamine derivative is preferable.

A known resin can be used as a binder resin for charge transport layer, and examples of the binder resin include the following resins. Namely, examples of the binder resin include a polyester resin, a polystyrene resin, an acrylic resin, a vinyl chloride resin, a polyvinyl acetate resin, a polyvinyl butyral resin, an epoxy resin, a polyurethane resin, a phenol resin, an alkyd resin, a polycarbonate resin, a silicone resin, a melamine resin, a styrene-acrylonitrile copolymer resin, a polymethacrylate resin, and a stylene-metacrylate copolymer resin. Those resins may be used alone, or two or more kinds of them may be used. Among those resins, a polycarbonate resin is preferred because it has a low water absorption and is mutually compatible with the charge transport material well.

The charge transport layer may contain other components such as an antioxidant according to need.

The content of the charge transport material is preferably 10 to 200 parts by mass, more preferably 20 to 100 parts by mass, based on 100 parts by mass of the binder resin for charge transport layer. When the content of the charge transport material is in the above range, since the electron-transporting properties can be satisfactorily secured, the charges generated in the charge generating layer can be satisfactorily transported to a surface of the electrophotographic photoreceptor, and, at the same time, the residual potential can be prevented from being increased by repetition use.

The thickness of the charge transport layer is difference depending on the charge transport material, the characteristics of the binder resin, and the mixing ratio of them, and it is preferably 10 to 40 μm.

(Protective Layer)

The electrophotographic photoreceptor of this invention may further have a protective layer on the photosensitive layer. The protective layer serves to protect the photoreceptor from external environment and impact. When the protective layer is formed, the protective layer is preferably constituted of inorganic particles and a binder resin (hereinafter referred to as a “binder resin for protective layer”), and the protective layer may contain other components such as an antioxidant and a lubricant according to need.

As the inorganic particles contained in the protective layer, particles of silica, alumina, strontium titanate, zinc oxide, titanium oxide, tin oxide, antimony oxide, indium oxide, bismuth oxide, indium oxide doped with tin, tin oxide doped with antimony or tantalum, zirconium oxide, and so on are preferably usable. Particularly preferred are hydrophobic silica of which surfaces are subjected to hydrophobic treatment, hydrophobic zirconia, and. sintered silica fine powder.

The number average primary particle size of the inorganic particles is preferably 1 to 300 nm, more preferably 5 to 100 nm.

The number average primary particle size of the inorganic particles is a value obtained by calculating the measured values in which 300 inorganic particles are randomly observed as primary particles by a transmission electron microscope magnified by 10000 times, as the number average diameter of the Feret diameter by way of image analysis.

The binder resin for protective layer may be a thermoplastic resin or a thermosetting resin. Examples of the binder resin for protective layer include a polyvinyl butyral resin, an epoxy resin, a polyurethane resin, a phenol resin, a polyester resin, an alkyd resin, a polycarbonate resin, a silicone resin, and a melamine resin.

Examples of a lubricant contained in the protective layer include a fine resin powder (for example, a fluororesin, a polyolefin resin, a silicone resin, a melamine resin, a urea resin, an acrylic resin, and a styrene resin), a metal oxide fine powder (for example, titanium oxide, aluminum oxide, and tin oxide), a solid lubricant (for example, polytetrafluoroethylene, polychlorotrifluoroethylene, polyfluorovinylidene, zinc stearate, and aluminum stearate), a silicone oil (tor example, dimethylsilicone oil, methylphenylsilicone oil, methyl hydrogen polysiloxane, cyclic dimethyl polysiloxane, alkyl-modified silicone oil, polyether-modified silicone oil, alcohol-modified silicone oil, fluorine-modified silicone oil, amino-modified silicone oil, mercapto-modified silicone oil, epoxy-modified silicone oil, carboxy-modified silicone oil, and higher fatty acid-modified silicone oil), a fluororesin powder (for example, tetrafluoroethylene resin powder, trifluorochloro ethylene resin powder, hexafluoroethylene propylene powder, vinyl fluoride resin powder, vinylidene fluoride resin powder, fluoro-di-chloro-ethylene resin powder and copolymers of these), a polyolefin resin powder (for example, homo-polymer resin powder such as a polyethylene resin powder, a polypropylene resin powder, a polybutene powder, and a polyhexene resin powder, a copolymer resin powder such as an ethylene-propylene copolymer and ethylene-butene copolymer, a terpolymer of these and hexane, and a polyolefin resin powder such as thermally transformed materials of these).

The molecular weight of the resin used as the lubricant and the particle size of the powder are suitably selected. The particle size of the resin is particularly preferably 0.1 to 10 μm. In order to uniformly disperse those lubricants, a dispersant may be added to the binder resin for protective layer.

<Method of Manufacturing Electrophotographic Photoreceptor>

A method of manufacturing an electrophotographic photoreceptor of this invention is not limited particularly, and in order to provide an intermediate layer, a charge generating layer and a charge transport layer, or a single photosensitive layer, and, if necessary, a protective layer on a conductive support, coating liquids capable of constituting the respective layers are prepared to be coated in sequence by a known coating method, and, thus, to be dried, whereby the respective layers can be formed in sequence. Specifically, examples of the coating methods include a dip coating, a spray coating, a spin coating, a bead coating, a blade coating, a beam coating, and a circular quantity control type coating method (using a slide hopper coating apparatus). The circular quantity control type coating method is described in detail in JP-A No. S58-189061, for example,

(Formation of Intermediate Layer)

In order to unevenly disperse the first metal oxide particles in the intermediate layer, there are no particular limitations, and the uneven distribution can be controlled by adjusting, for example, a combination of the particle sizes of the first and second metal oxide particles, a combination of surface treatment agent species, a difference of the hydrophobicity between the first and second metal oxide particles, and a difference of compatibility to a binder resin and/or a solvent between the first and second metal oxide particles. Since there are various combinations in those parameters, that makes a general description difficult. But, if a combination of the parameters such that the second metal oxide particle has a good compatibility with the binder resin and the first metal oxide particle has a poor compatibility with the binder resin, is selected, the first metal oxide particles tend to aggregate in the binder resin during a process to dry a solvent contained in an intermediate layer coating liquid, and therefore, the first metal oxide particles can be unevenly dispersed in the intermediate layer.

In order to unevenly distribute the first metal oxide particles, a special process is not required, and the first and second metal oxide particles are suitably selected to be mixed in a coating liquid as follows, whereby a coating film can be formed. This is because the first metal oxide particles are gradually distributed unevenly in a process of drying the coating. Since it is preferable that the amount of the second metal oxide particles contributing to the enhancement of the electron-transporting properties of the entire intermediate layer is larger than the amount of the first metal oxide particles, the first metal oxide particles are pushed by the larger amount of the second metal oxide particles and thereby can be distributed unevenly, or, the first metal oxide particles themselves loosely aggregate in the binder resin and thereby may be distributed unevenly.

The formation of the intermediate layer is not limited particularly, and the following methods can be used, for example. First, a binder resin is dissolved or dispersed in a solvent, and the first and second metal oxide particles are then added to the obtained dispersion liquid and dispersed until it is uniform, and, thus, to prepare the dispersion liquid. After that, the dispersion liquid is left to be still for approximately twenty-four hours and it is filtered, and, thus, to prepare a coating liquid for intermediate layer formation. Subsequently, the coating liquid is coated on a conductive support by the above method to be dried, and, thus, to form the intermediate layer.

The binder resin concentration in the coating liquid preparation can be suitably selected according to the film thickness of the intermediate layer and a coating method. The content of the solvent is preferably 100 to 3000 parts by mass, more preferably 500 to 2000 parts by mass, based on 100 parts by mass of the binder resin. The total concentration of the first and second metal oxide particles is preferably 80 to 800 parts by mass, more preferably 150 to 500 parts by mass, based on 100 parts by mass of the binder resin. The component ratio in the coating liquid is equal to a component ratio in the formed intermediate layer.

As a usable solvent in the intermediate layer formation, a solvent which can disperse metal oxide particles well and can dissolve a binder resin including a polyamide resin is preferable. More specifically, preferred are alcohols having a carbon number of 2 to 4, such as ethanol, n-propyl alcohol, isopropyl alcohol, n-butanol, t-butanol, and sec-butanol because the alcohols express good solubility and coating performance to a polyamide resin which is considered preferable as the binder resin. Those alcohols can be mixed for use. In order to enhance preservability and dispersibility of inorganic fine particles, the following co-solvents can be used with the above solvent. Examples of co-solvents for obtaining preferable effects include methanol, benzyl alcohol, toluene, cyclohexanone, and tetrahydrofuran.

Examples of means for dispersing conductive fine particles and metal oxide particles include an ultrasonic disperser, a bead mill, a ball mill, a sand grinder and a homomixer, but the dispersing means is not limited to them. In the coating liquid for intermediate layer, the image defects can be prevented by filtering to remove foreign matters and agglomerates before the coating liquid for intermediate layer is coated.

A method of drying a coating film of the coating liquid for intermediate layer can be suitably selected from known drying methods according to the kind of a solvent and the thickness of the film to be formed, and thermal drying is particularly preferable. As drying conditions, the coating film can be dried at 100 to 150° C. for 10 to 60 minutes, for example.

(Formation of Charge Generating Layer)

In the formation of the charge generating layer, a charge generating material is dispersed in a solution prepared by dissolving a binder resin for charge generating layer with a solvent, using a disperser, and a coating liquid is prepared. Subsequently, it is preferable that the coating liquid is coated in a constant film thickness by the above-described coating method, and a coating film is dried to produce the charge generating layer. When a single-layer photosensitive layer including a charge generating material and a charge transport material is formed, the photosensitive layer can be formed by the same method as the method of charge generating layer formation.

The concentration of the binder resin for charge generating layer in the charge generating layer coating liquid can be suitably selected to have a viscosity suitable for coating, and the consent of a solvent is preferably 100 to 5000 parts by mass, more preferably 1000 to 4000 parts by mass, based on 100 parts by mass of the binder resin for charge generating layer. The concentration of the charge generating material is preferably 80 to 400 parts by mass, more preferably 150 to 300 parts by mass, based on 100 parts by mass of the binder resin for charge generating layer.

Examples of the solvent used for dissolving and coating the binder resin for charge generating layer, which is used in the charge generating layer, include toluene, xylene, methyl ethyl ketone, cyclohexanone, 3-methyl-2-butanon, cyclohexane, ethyl acetate, butyl acetate, methanol, ethane, propanol, butanol, methyl cellosolve, ethyl, cellosolve, tetrahydrofuran, 1-dioxane, 1,3-dioxolane, 4-methoxy-4-methyl-2-pentanon pyridine, and diethyl amine, but the solvent is not limited to them. Those organic solvents may be used singly, or two or more kinds of them may be used in combination. More preferred are methyl ethyl ketone and cyclohexanone.

As the means for dispersing the charge generating material, the same method as the above means for dispersing the metal oxide particles in the intermediate layer can be adopted. In the coating liquid for charge generating layer, the image defects can be prevented by filtering to remove foreign matters and agglomerates before the coating liquid for charge generating layer is coated. Also, regarding the coating method, the above methods can be adopted.

(Formation of Charge Transport Layer)

In the formation of the charge transport layer, a charge transport material is dissolved or dispersed in a solution prepared by dissolving a binder resin for charge transport layer with a solvent to prepare a coating liquid. Subsequently, it is preferable that the coating liquid is coated in a constant film thickness by the above coating method, and a coating film, is dried to produce the charge transport layer.

The concentration of the binder resin for charge transport layer in the charge transport layer coating liquid can be suitably selected so as to have a viscosity suitable for the above coating method. The content of the solvent, is preferably 100 to 1000 parts by mass, more preferably 400 to 900 parts by mass, based on 100 parts by mass of the binder resin for charge transport layer. The concentration of the charge transport material is preferably 30 to 150 parts by mass, more preferably 60 to 90 parts by mass, based on 100 parts by mass of the binder resin.

As the means for dispersing the charge transport material, the same method as the above means for dispersing the metal oxide particles in the intermediate layer can be adopted. In the coating liquid for charge transport layer, the image defects cam be prevented by filtering to remove foreign matters and agglomerates before the coating liquid for charge transport layer is coated.

<Protective Layer>

Also, regarding the method of protective layer formation, the same method as the above method of intermediate layer formation can be adopted. A coating liquid is prepared by dispersing or dissolving a component forming the protective layer in a solvent, and, coated in a desired thickness by the above-mentioned coating method, and, thus, dried, whereby the protective layer can be formed.

<Image Forming Apparatus>

The image forming apparatus of this invention has at least the electrophotographic photoreceptor of the invention.

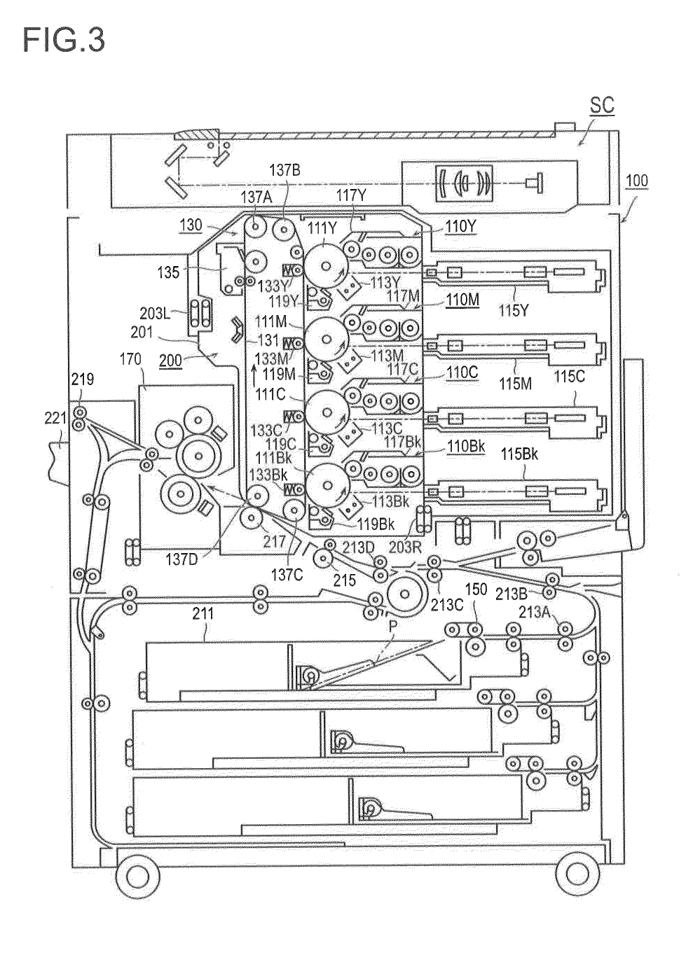

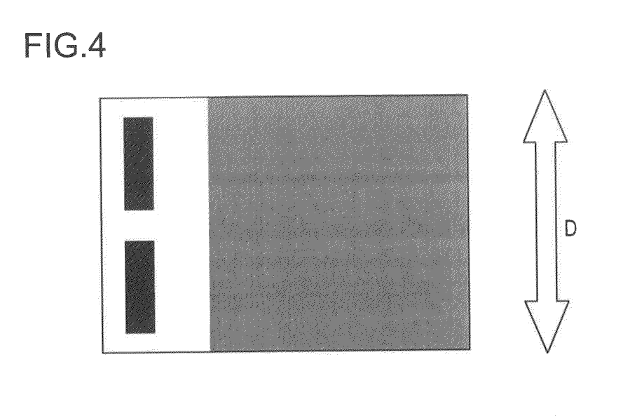

FIG. 3 is a schematic cross-sectional view showing an example of a configuration of the image forming apparatus of this invention. The image forming apparatus 100 is a tandem type color image forming apparatus and has four image forming units 110Y, 110M, 110C, and 110Bk, an endless belt-like intermediate transfer body unit 130, paper feeding and conveying means 150, and fixing means 170. An image reading device SC is disposed above a main body of the image forming apparatus 100.

The image forming units 110Y, 110M, 110C, and 110Bk are arranged side by side in a vertical direction. The image forming units 110Y, 110M, 110C, and 110Bk have electrophotographic photoreceptors 111Y, 111M, 111C, and 111Bk as first image carriers, charging means 113Y, 113M, 113C, and 113Bk, exposure means 115Y, 115M, 115C, end 115Bk, developing means 117Y, 117M, 117C, and 117Bk, and cleaning means 119Y, 119M, 119C, and 119Bk, which are sequentially arranged in the drum rotating direction around the photoreceptors. Yellow (Y), magenta (M), cyan (C), and black (Bk) toner images can be formed respectively on the electrophotographic photoreceptors 111Y, 111M, 111C, and 111Bk. The image forming units 110Y, 110M, 110C, and 110Bk are constituted in the same way, except that the colors of the toner images formed on the electrophotographic photoreceptors 111Y, 111M, 111C, and 111Bk are different from each other, and therefore, the image forming unit 110Y will be described, as an example, as follows.

The electrophotographic photoreceptor 111Y is the electrophotographic photoreceptor according to this invention, and the intermediate layer constituting the electrophotographic photoreceptor contains the first metal oxide particles having a high function of blocking irregular electrons, the second metal oxide particles having high electron-transporting properties, and the binder resin. The first metal oxide particles are unevenly distributed in the thickness direction of the intermediate layer.

The charging means 113Y applies a uniform potential to the electrophotographic photoreceptor 111Y. In this embodiment, a corona discharge type electrifier is preferably used as the charging means 113Y.

The exposure means 115Y has a function of light exposing the electrophotographic photoreceptor 111Y to which the uniform potential has been applied by the charging means 113Y, based on an image signal (yellow image signal) and forming an electrostatic latent image corresponding to a yellow image. The exposure means 115Y may be constituted of an LED in which light-emitting elements are arranged in the form of an array in the axial direction of the electrophotographic photoreceptor 111Y and an imaging element or may be a laser optical system.

An exposing light source is preferably a semiconductor laser or a light-emitting diode such that the oscillation wavelength is in a range of not less than 50% of the maximum absorbance of the charge generating material to be used. For example, when a mixture of 2,3-butanediol-added titanyl phthalocyanine and a titanyl phthalocyanine which is not added with butanediol is used as the charge generating material, the oscillation wavelength is preferably 650 to 800 nm. An exposure dot diameter in the main scanning direction of writing can be narrowed to 10 to 100 μm, using those exposure light sources, and digital exposure can be performed onto the organic photoreceptor, whereby an electrophotographic image having a high resolution of 600 to 2400 dpi (dpi: dot number per 2.54 cm) or more can be formed.

The exposure dot diameter refers to an exposure beam length (Ld measured at the position of the maximum length) along the main-scanning direction in the region exhibiting an exposure beam intensity of not less than 1/e² of the peak intensity.

The developing means 117Y is configured to supply toner to the electrophotographic photoreceptor 111Y and to develop the electrostatic latent image formed on a surface of the electrophotographic photoreceptor 111Y.

The cleaning means 119Y may have a roller in press contact with the surface of the electrophotographic photoreceptor 111Y or a blade,

The endless belt-like intermediate transfer body unit 130 is provided to be abuttable against the electrophotographic photoreceptors 111Y, 111M, 111C, and 111Bk. The endless belt-like intermediate transfer body unit 130 has an endless belt-like intermediate transfer body 131 as a second image carrier, primary transfer rollers 133Y, 133M, 133C, and 133Bk arranged to be abutted against the endless belt-like intermediate transfer body 131, and cleaning means 135 for the endless belt-like intermediate transfer body 131.

The endless belt-like intermediate transfer body 131 is wound and rotatably supported by rollers 137A, 137B, 137C, and 137D.

In the image forming apparatus 100, the electrophotographic photoreceptor 111Y, the developing means 117Y, and the cleaning means 119Y are integrally coupled to form a process cartridge (image forming unit) configured to be freely detachable from the apparatus body. Alternatively, there may be provided a process cartridge (image forming unit) in which at least one member selected from a group constituted of the charging means 113Y, the exposure means 115Y, the developing means 117Y, the primary transfer roller 133Y, and the cleaning means 119Y and the electrophotographic photoreceptor 111Y are configured integrally.

A process cartridge 200 has a housing 201 and the electrophotographic photoreceptor 111Y, the charging means 113Y, the developing means 117Y, the cleaning means 119Y, and the endless belt-like intermediate transfer body unit 130 stored in the housing 201. The apparatus body has support rails 203L and 203R as means of guiding the process cartridge 200 into the apparatus body. According to this constitution, the process cartridge 200 is detachable from the apparatus body. Those process cartridges 200 may be a single image forming unit configured to be detachable from the apparatus body.

The paper feeding and conveying means 150 is provided so that a transfer material P in a paper feeding cassette 211 can be conveyed to a secondary transfer roller 217 via intermediate rollers 213A, 213B, 213C, and 213D and a resist roller 215.

The fixing means 170 applies fixing processing to a color image transferred by the secondary transfer roller 217. Paper discharge rollers 219 hold the transfer material P treated to fix in between and place it on a paper discharge tray 221 provided outside the image forming apparatus.

In the image forming apparatus 100 thus constituted, an image is formed by the image forming units 110Y, 110M, 110C, and 110Bk. More specifically, the surfaces of the electrophotographic photoreceptors 111Y, 111M, 111C, and 111Bk are negatively charged by corona discharging of the charging means 113Y, 113M, 113C, and 113Bk. Subsequently, the surfaces of the electrophotographic photoreceptors 111Y, 111M, 111C, and 111Bk are exposed by the exposure means 115Y, 115M, 115C, and 115Bk, based on an image signal, and an electrostatic latent image is formed. Subsequently, toner is applied to the surfaces of the electrophotographic photoreceptors 111Y, 111M, 111C, and 111Bk, and images are developed by the developing means 117Y, 117M, 117C, and 117Bk.

Subsequently, the primary transfer rollers (primary transfer means) 133Y, 133M, 133C, and 133Bk are abutted against the rotating endless belt-like intermediate transfer body 131. Consequently, image of each color formed on each of the electrophotographic photoreceptors 111Y, 111M, 111C, and 111Bk is transferred onto the rotating endless belt-like intermediate transfer body 131 to sequentially transfer a color image (primary transfer). During the image forming processing, the primary transfer roller 133Bk is always abutted against the electrophotographic photoreceptor 111Bk. Meanwhile, the other primary transfer rollers 133Y, 133M, and 133C are abutted respectively against the corresponding electrophotographic photoreceptors 111Y, 111M, and 111C only at the time of the color image formation.

Then, after the primary transfer rollers 133Y, 133M, 133C, and 133Bk are separated from the endless belt-like intermediate transfer body 131, toner remaining on the surfaces of the electrophotographic photoreceptors 111Y, 111M, 111C, and 111Bk is removed by the cleaning means 119Y, 119M, 119C, and 119Bk. Then, in preparation for the next image formation, the surfaces of the electrophotographic photoreceptors 111Y, 111M, 111C, and 111Bk are electricity-removed by electricity removing means (not shown) according to need and negatively charged by the charging means 113Y, 113M, 113C, and 113Bk.

Meanwhile, the transfer material P (a support such as normal paper and a transparent sheet carrying a final image) stored in the paper feeding cassette 211 is fed by the paper feeding and conveying means 150 and conveyed to the secondary transfer roller (secondary transfer means) 217 via the intermediate rollers 213A, 213B, 213C, and 213D and the resist roller 215. Then, the secondary transfer roller 217 is abutted against the rotating endless belt-like intermediate transfer body 131, and color images are collectively transferred onto the transfer material P (secondary transfer). The secondary transfer roller 217 is abutted against the endless belt-like intermediate transfer body 131 only at the time of the secondary transfer onto the transfer material P. After that, the transfer material P collectively transferred with the color images is separated at a portion where the curvature of the endless belt-like intermediate transfer body 131 is large.

The transfer material P collectively transferred with the color images as described above is subjected to fixing processing by the fixing means 170, and thereafter, the transfer material P is held between the paper discharge rollers 219 and placed on the paper discharge tray 221 provided outside the apparatus. After the transfer material P collectively transferred with the color images is separated from the endless belt-like intermediate transfer body 131, residual toner on the endless belt-like intermediate transfer body 131 is removed by the cleaning means 135.

As described above, since the intermediate layers of the electrophotographic photoreceptors 111Y, 111M, 111C, and 111Bk included in the image forming apparatus 100 of this embodiment contain the unevenly distributed first metal oxide particles and the second metal oxide particles, the intermediate layers have sufficient electron-transporting properties, and the density unevenness of an image can be reduced. Further, the intermediate layers of the electrophotographic photoreceptors 111Y, 111M, 111C, and 111Bk have high irregular electron blocking properties, and therefore, particularly in the electrophotographic photoreceptors 111Y, 111M, 111C, and 111Bk having sensitive charge generating layers, unnecessary injection of positive holes from the conductive support and movement of unnecessary thermal excitation carrier from the charge generating layer can be reduced, and the image defects such as black spots and fog can be suppressed.

### EXAMPLES

Hereinafter, although this invention will be described using Examples, the invention is not limited to only the following Examples. “Part” described in the following Examples and Comparative Examples represents “parts by mass”.

(Preparation of Surface-treated Metal Oxide Particle)

<Preparation of Surface-treated Metal Oxide Particle 1>

500 parts by mass of inorganic treated titanium oxide (F-1S02 manufactured by Showa Denko K.K.) in which silica treatment was applied to anatase-type titanium oxide having a primary particle size of 90 nm, 10 parts by mass of methyl hydrogen polysiloxane (MHPS), and 1300 parts by mass of toluene were stirred and mixed, and thereafter, wet cracked by a bead mill at a temperature of 35° C. for a mill residence time of 35 minutes. Toluene was separated and removed by reduced-pressure distillation from the slurry obtained by the wet cracking. MHPS was burnt onto the dried product at 120° C. for 1.5 hours. After that, the dried product was crushed by a pin mill, and the surface-treated metal oxide particles 1 were obtained.

<Preparation of Surface-treated Metal Oxide Particle 2>

500 parts by mass of inorganic treated titanium oxide (MT-500SA manufactured by Tayca Corporation) in which silica-alumina treatment was applied to rutile type titanium oxide having a primary particle size of 35 nm, 15 parts by mass of methyl hydrogen polysiloxane (MHPS), and 1500 parts by mass of toluene were stirred and mixed, and thereafter, wet cracked by a bead mill at a temperature of 35° C. for a mill residence time of 25 minutes. Toluene was separated and removed by reduced-pressure distillation from the slurry obtained by the wet cracking. MHPS was burnt onto the dried product at 120° C. for 2 hours. After that, the dried product was crushed by a pin mill, and the surface-treated metal oxide particles 2 were obtained.

<Preparation of Surface-treated Metal Oxide Particle 3>

The surface-treated metal oxide particles 3 was obtained in the same manner as the surface-treated metal oxide particles 2, except that the inorganic treated titanium oxide in the surface-treated metal oxide particle 2, in which the silica-alumina treatment was applied to the rutile type titanium oxide having a primary particle sire of 35 nm, was changed into rutile type titanium oxide having a primary particle size of 35 nm, and the amount of MHPS was changed into 15 parts by mass.

<Preparation of Surface-treated Metal Oxide Particle 4>

500 parts by mass of rutile type titanium oxide having a primary particle size of 35 nm was stirred and mixed with 1500 parts by mass of toluene, 25 parts by mass of titanium acylate (Orgatics TPHS manufactured by Matsumoto Fine Chemical Co., Ltd.) was then added, and the mixture was stirred at 50° C. for 2 hours. After that, toluene was distilled away by reduced-pressure distillation and the particles were baked at 110° C. for 2 hours. 500 parts by mass of the obtained metal oxide particles, 20 parts by mass of MHPS, and 1500 parts by mass of toluene were stirred and mixed, and thereafter, the wet cracked by a bead mill at a temperature of 35° C. for a mill residence time of 30 minutes. Toluene was separated and removed from the obtained slurry by reduced-pressure distillation. MHPS was burnt onto an obtained dried product at 120° C. for 2 hours. After that, the dried product was crushed by a pin mill, and the surface-treated metal oxide particles 4 were obtained.

<Preparation of Surface-treated Metal Oxide Particle 5>

500 parts by mass of rutile type titanium oxide having a primary particle size of 35 nm was stirred and mixed with 2000 parts by mass of toluene, 65 parts by mass of 3-methacryloxypropyl trimethoxy silane (KBM-503 manufactured by Shin-Etsu Chemical Co., Ltd.) was then added, and the mixture was stirred at 50° C. for 3 hours. After that, toluene was distilled away by reduced-pressure distillation and the particles were baked at 130° C. for 3 hours. Consequently, the surface-treated metal oxide particles 5 were obtained.

<Preparation of Surface-treated Metal Oxide Particle 6>

500 parts by mass of inorganic treated titanium oxide (MT-100SA manufactured by Tayca Corporation) in which silica-alumina treatment was applied to rutile type titanium oxide having a primary particle size of 15 nm, 25 parts by mass of MHPS, and 1300 parts by mass of toluene were stirred and mixed, and thereafter, wet cracked by a bead mill at a temperature of 35° C. for a mill residence time of 40 minutes. Toluene was separated and removed by reduced-pressure distillation from the slurry obtained by the wet cracking. MHPS was burnt onto the dried product at 120° C. for 2 hours. After that, the dried product was crushed by a pin mill, and the surface-treated metal oxide particles 6 were obtained.

<Preparation of Surface-treated Metal Oxide Particle 7>

The surface-treated metal oxide particle 7 was obtained in the same manner as the surface-treated metal oxide particle 5, except that the primary particle size of the rutile type titanium oxide of the surface-treated metal oxide particle 5 was changed into 15 nm, and the amount of KBM-503 was changed into 60 parts by mass.

<Preparation of Surface-treated Metal Oxide Particle 8>

The surface-treated metal oxide particle 8 was obtained in the same manner as the surface-treated metal oxide particle 7, except that 3-methacryloxypropyl trimethoxy silane (KBM-503) was changed into 3-acryloxypropyl trimethoxy silane (KBM-5103 manufactured by Shin-Etsu Chemical Co., Ltd.), and the additive amount of KBM-503 was changed into 80 parts by mass.

<Preparation of Surface-treated Metal Oxide Particle 9>

The surface-treated metal oxide particle 9 was obtained in the same manner as the surface-treated metal oxide particle 4, except that the rutile type titanium oxide having a primary particle size of 35 nm in the surface-treated metal oxide particle 4 was changed into inorganic treated titanium oxide (manufactured by Tayca Corporation) in which silica treatment was applied to the anatase-type titanium oxide having a primary particle size of 6 nm, the additive amount of titanium acylate (Orgatics TPHS manufactured by Matsumoto Fine Chemical Co., Ltd.) was changed into 45 parts by mass, and the additive amount of MHPS was changed into 12.5 parts by mass.

<Preparation of Surface-treated Metal Oxide Particle 10>

500 parts by mass of inorganic treated titanium oxide (manufactured by Tayca Corporation) in which silica treatment was applied to anatase-type titanium oxide having a primary particle size of 30 nm, 40 parts by mass of MHPS, and 1800 parts by mass of toluene were stirred and mixed, and thereafter, wet cracked by a bead mill at a temperature of 35° C. for a mill residence time of 60 minutes. Toluene was separated and removed by reduced-pressure distillation from the slurry obtained by the wet cracking. MHPS was burnt onto the dried product at 120° C. for 2 hours. After that, the dried product was crushed by a pin mill, and the surface-treated metal oxide particles 10 were obtained.

<Preparation of Surface-treated Metal Oxide Particle 11>

500 parts by mass of inorganic treated zinc oxide (manufactured by Showa Denko K.K.) in which silica treatment was applied to zinc oxide having a primary particle size of 25 nm, 35 parts by mass of MHPS, and 1700 parts by mass of toluene were stirred and mixed, and thereafter, wet cracked by a bead mill at a temperature of 35° C. for a mill residence time of 40 minutes. Toluene was separated and removed by reduced-pressure distillation from the slurry obtained by the wet cracking. MHPS was burnt onto the dried product at 120° C. for 2 hours. After that, the dried product was crushed by a pin mill, and the surface-treated metal oxide particles 11 were obtained.

<Preparation of Surface-treated Metal Oxide Particle 12>

500 parts by mass of zinc oxide having a primary particle size of 35 nm was stirred and mixed with 2000 parts by mass of toluene, 65 parts by mass of 3-methacryloxypropyl trimethoxy silane (KBM-503) was then added, and the mixture was stirred at 50° C. for 2 hours. After that, toluene was distilled away by reduced-pressure distillation and the particles were baked at 130° C. for 3 hours. Consequently, the surface-treated metal oxide particles 12 were obtained.

TABLE 1

| Surface-treated | | | |
|---|---|---|---|
| metal oxide | | Surface | Specific |
| particle | Particle species | treatment | gravity |
| 1 | 90 nm titanium | Silica, | 3.5 |
| | oxide (anatase) | MHPS | |
| 2 | 35 nm titanium | Silica, | 3.8 |
| | oxide (rutile) | alumina, | |
| | | MHPS | |
| 3 | 35 nm titanium | MHPS | 3.6 |
| | oxide (rutile) | | |
| 4 | 35 nm titanium | TPHS + MHPS | 3.6 |
| | oxide (rutile) | | |
| 5 | 35 nm titanium | KBM503 | 3.9 |
| | oxide (rutile) | | |
| 6 | 15 nm titanium | Silica, | 3.7 |
| | oxide (rutile) | alumina, | |
| | | MHPS | |
| 7 | 15 nm titanium | KBM503 | 3.5 |
| | oxide (rutile) | | |
| 8 | 15 nm titanium | KBM5103 | 3.4 |
| | oxide (rutile) | | |
| 9 | 6 nm titanium | Silica, | 3.5 |
| | oxide (rutile) | TPHS + MHPS | |
| 10 | 30 nm titanium | Silica, | 3.3 |
| | oxide (anatase) | MHPS | |
| 11 | 25 nm zinc oxide | Silica, | 4.6 |
| | | MHPS | |
| 12 | 35 nm zinc oxide | KBM503 | 4.8 |

MHPS: Methyl hydrogen polysiloxane
TPHS: Titanium acylate
KBM503: 3-methacryloxypropyl trimethoxy silane
KBM5103: 3-acryloxypropyl trimethoxy silane

### Example 1

### Photoreceptor 1

“Photoreceptor 1” having a laminate structure obtained by forming successively an intermediate layer, a charge generating layer, and a charge transport layer on a conductive support was produced by the following procedure.

<Production of Conductive Support>

A tube made of aluminum alloy of a length of 362 mm was attached to an NC lathe and subjected to cutting processing so that the outer diameter was 59.95 mm and Rzⱼᵢₛ of the surface was 1.2 μm by a sintered diamond bite.

<Production of Photoreceptor 1>

(Formation of Intermediate Layer)

100 parts by mass of the following polyamide resin (N-1) as a binder resin was added to 1850 parts by mass of a mixed solvent of ethanol/n-propyl alcohol/tetrahydrofuran (volume ratio: 50/20/30) and stirred and mixed at 20° C. 130 parts by mass of the surface-treated metal oxide particles 6 as the first metal oxide particles and 150 parts by mass of the surface-treated metal oxide particles 1 as the second metal oxide particles were added to the solution and dispersed by a bead mill for a mill residence time of 2 hours. Then, the solution was left to stand still for the whole day and night and thereafter filtered, whereby a coating liquid for intermediate layer was obtained. The filtration was performed under a pressure of 50 kPa, using a Rigimesh filter (manufactured by Nihon Pall Ltd.) with a nominal filtering accuracy of 5 μm as a filter. The coating liquid for intermediate layer thus obtained was coated to an outer periphery of the washed substrate by dip coating and dried at 120° C. for 30 minutes, and the “intermediate layer” having a dried film thickness of 2 μm was formed.

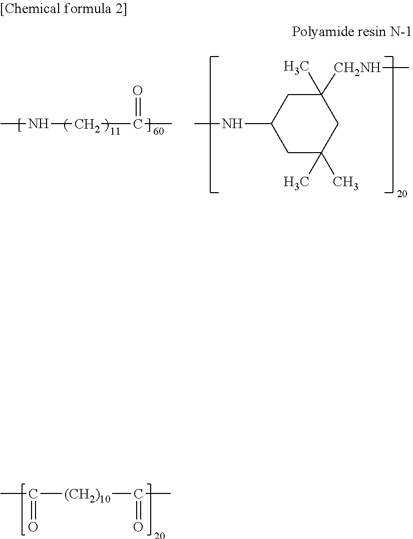

<Production of Charge Generating Layer>

(Synthesis of CG-1)

Rough titanyl phthalocyanine was synthesized from 1,3-diiminoisoindoline and titanium tetra-n-butoxide. A solution prepared by dissolving the obtained rough titanyl phthalocyanine in sulfuric acid was injected into water to precipitate crystal. After the solution was filtered, the obtained crystal was washed well with water, and a wet paste product was obtained. Subsequently, the wet paste product was frozen in a freezer, defrosted again and thereafter filtered and dried, whereby amorphous titanyl phthalocyanine was obtained,

The obtained amorphous titanyl phthalocyanine and (2R,3R)-2,3-butanediol were mixed in ortho-dichlorobenzene (ODB) so that the equivalent ratio of (2R,3R)-2,3-butanediol to amorphous titanyl phthalocyanine was 0.6. The obtained mixture was heated and stirred at 60 to 70° C. for 6 hours. The obtained solution was left to stand still for the whole day and night, and thereafter methanol was further added to precipitate crystal. After the solution was filtered, the obtained crystal was washed with methanol, and a charge generating material CG-1 containing (2R,3R)-2,3-butanediol added titanyl phthalocyanine was obtained.

As a result of measurement of the X-ray diffraction spectrum of the charge generating material CG-1, peaks at 8.3°, 24.7°, 25.1°, and 26.5° C. were observed. It was deduced that the obtained charge generating material CG-1 was a mixture of 1:1 adduct of titanyl phthalocyanine and (2R,3R)-2,3-butanediol and titanyl phthalocyanine (non-adduct).

The following components were mixed and dispersed for 0.5 hours at a circulation flow rate of 40 L/H by a circulation-type ultrasonic homogenizer RUS-600TCVP (manufactured by NISSEI Corporation, 19.5 kHz, 600 W), and the coating liquid for charge generating layer was prepared. The coating liquid for charge generating layer was coated onto the intermediate layer by dip coating in the same manner as the intermediate layer and thereafter dried, whereby the charge generating layer having a thickness of 0.5 μm was formed.

(Coating Liquid for Charge Generating Layer)

| | |
|---|---|
| Charge generating material: CG-1 | 24 parts |
| Polyvinyl butyral resin “Esrec BL-1” (produced by Sekisui | 12 parts |
| Chemical Co., Ltd.) | |
| Solvent: methyl ethyl ketone/cyclohexanone = 4/1 (V/V) | 400 parts |

(Measurement of Absorbance Ratio)

In a sample used for measuring a reflectance spectrum and obtained by coating and drying the charge generating layer on an aluminum support so treat the film thickness after drying was 0.5 μm, a relative reflectance spectrum was measured by the following procedure, using an optical film thickness measuring device Solid Lambda Thickness (manufactured by Spectra Co-op).

1) First, a reflection intensity of the aluminum support at each wavelength was measured as a base line. Subsequently, the reflection intensity of the photoreceptor sample at each wave length was measured. Then, a value obtained by dividing the reflection intensity of the photoreceptor sample at each wavelength by the reflection intensity of the aluminum support was a “relative reflectance (Rλ)”, and the relative reflectance spectrum was obtained.

(2) The obtained relative reflectance spectrum of the photoreceptor sample was converted into the absorbance spectrum by the following formula.

Absλ=−log(Rλ)

(In the formula, Rλ represents the relative reflectance obtained by dividing the reflection intensity of the photoreceptor sample at the wavelength λ by the reflection intensity of the aluminum support, at the wavelength λ)

(3) Subsequently, in order to remove irregularities due to interference fringes, the absorbance spectrum data converted by the formula (2) was approximated to a secondary polynomial expression in a wavelength region of 765 to 795 nm and a wavelength region of 685 to 715 nm.

(4) The absorbance Abs(780) at a wavelength of 780 nm and the absorbance Abs(700) at a wavelength of 700 nm in the approximated secondary polynomial expression were obtained, and the absorbance ratio (Abs(780)/Abs(700)) was calculated. The obtained absorbance ratio (Abs(780)/Abs(700)) was 0.99.

(Production of Charge Transport Layer)

A coating liquid for charge transport layer was prepared by mixing the following components. The coating liquid for charge transport layer was coated onto the charge generating layer by dip coating in the same manner as above and thereafter dried, and a charge transport layer having a thickness of 25 μm was formed. Consequently, the electrophotographic photoreceptor was obtained. The following charge transport material. 225.0 parts

| | | |
|---|---|---|
| Polycarbonate “Z300 (produced by Mitsubishi Gas | 300.0 | parts |
| Chemical Company, Inc.)” | | |
| Antioxidant “Irganox 1010 (produced by Nihon Ciba- | 6.0 | parts |
| Geigy K.K.)” | | |
| Tetrahydrofuran/toluene mixture (volume ratio: 3/1) | 2000.0 | parts |
| Silicone oil “KF-54 (produced by Shin-Etsu Chemical | 1.0 | part |
| Co., Ltd.)” | | |

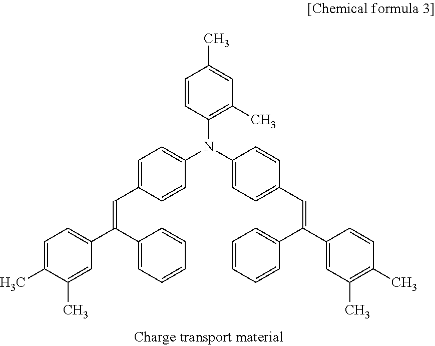

(Observation of Intermediate Layer)

As a result of cutting a produced photoreceptor and observing a cross section of the intermediate layer by TEM, a state indicated by FIG. 2 was observed. When the cross section of the intermediate layer was divided into three layers, a ratio of the first metal oxide particles existing in a layer closest to the substrate to the total solid content was 1.6 times an average ratio of the entire intermediate layer. If was observed that the intermediate layer was a single layer. In Table 2-1 and Table 2-2, when the intermediate layer equally divided into three layers in the cross section, Vₐ, V_{b}, and V_{c} represent the volumes of the first metal oxide particles contained in the equally divided individual layers in the order of Vₐ, V_{b}, and V_{c} from the surface side of the intermediate layer. V₁ represents the volume of the first metal oxide particles contained in the entire intermediate layer.

### Examples 2 to 7

### Photoreceptors 2 to 7

<Production of Photoreceptors 2 to 7>

An electrophotographic photoreceptor was produced in the same manner as Example 1, except that the surface-treated metal oxide particles contained in the intermediate layer of the photoreceptor 1 were changed as in the following Table 2-1.

### Example 8

### Photoreceptor 8

<Production of Photoreceptor 8>

The photoreceptor 8 was produced in the same manner as the Example 2, except that the coating liquid for charge generating layer in the photoreceptor 2 was changed as follows.

(Coating Liquid for Charge Generating Layer)

The following components were mixed and dispersed for 15 hours using a sand mill disperser, and, thus, to prepare the coating liquid for charge generating layer. The coating liquid was coated on an intermediate layer by dip coating, and a “charge generating layer” having a dried film thickness of 0.5 μm was formed.

| | | |
|---|---|---|
| Y-type phthalocyanine (a titanyl phthalocyanine | 20 | parts by mass |
| pigment exhibiting a maximum diffraction peak at | | |
| a Bragg angle of (2θ ± 0.2°)27.3° in | | |
| an X-ray diffraction spectrum using Cu-Kα | | |
| characteristic X-ray) | | |
| Polyvinyl butyral (BM-1 produced by Sekisui | 10 | parts by mass |
| Chemical Co., Ltd.) | | |
| Methyl ethyl ketone | 700 | parts by mass |
| Cyclohexanone | 300 | parts by mass |

### Comparative Examples 1 and 2

### Photoreceptors 9 and 10

<Production of Photoreceptors 9 and 10>

An electrophotographic photoreceptor was produced in the same manner as the Example 1, except that the surface-treated titanium oxide particles contained in the intermediate layer of the photoreceptor 1 were changed as in the following Table 2-2.

### Comparative Example 3

### Photoreceptor 11

<Production of Photoreceptor 11>

The photoreceptor 11 was produced in the same manner as the Example 1, except that the intermediate layer in the photoreceptor 1 was changed as follows.

(Preparation of Coating Liquid 11-1 for Intermediate Layer)

150 parts by mass of alkyd resin (BECKOLITE M-6401-50 produced by DIC corporation) and 85 parts by mass of melamine resin (SUPER BECKAMINE G-821-60 produced by DIC Corporation) were added as a binder resin to 1000 parts by mass of methyl ethyl ketone and stirred and mixed at 20° C. 500 parts by mass of titanium oxide (PT-401M produced by Ishihara Sangyo Kaisha, Ltd.) having a primary particle size of 70 nm was added as the first metal oxide particles to the solution and dispersed by a bead mill for a mill residence time of 1 hour. After that, filtration was performed using the Rigimesh filter (manufactured by Nihon Pall Ltd.) with a nominal filtering accuracy of 5 μm, whereby the coating liquid 11-1 for intermediate layer was obtained,

(Preparation of Coating Liquid 11-2 for Intermediate Layer)

150 parts by mass of alkyd resin (BECKOLITE M-6401-50 produced by DIC corporation) and 85 parts by mass of melamine resin (SUPER BECKAMINE G-821-60 produced by DIC Corporation) were added as a binder resin to 1000 parts by mass of methyl ethyl ketone and stirred and mixed at 20° C. 500 parts by mass of tin oxide (NanoTek SnO₂ produced by C. I. Kasei Co., Ltd.) having a primary particle size of 21 nm was added as the second metal oxide particles to the solution and dispersed by a bead mill for a mill residence time of 1 hour. After that, filtration was performed using the Rigimesh filter (manufactured by Nihon Pall Ltd.) with a nominal filtering accuracy of 5 μm, whereby the coating liquid 11-2 for intermediate layer was obtained.

<Formation of Intermediate Layer>

The coating liquid 11-2 was coated to an outer periphery of the washed substrate by dip coating and dried at 140° C. for 30 minutes, and the “intermediate layer 1” having a dried film thickness of 3 μm was formed. After that, the coating liquid 11-1 was coated onto the intermediate layer 1 by the same dip coating as the dip coating method for the intermediate layer 1 and dried at 140° C. for 30 minutes, and the “intermediate layer 2” having a dried film thickness of 3 μm was formed. The two intermediate layers were thus formed.

(Observation of Intermediate Layer)

As a result of cutting the produced photoreceptor and observing a cross section of the intermediate layer by TEM, it was confirmed that there was an interface between the intermediate layer 1 and the intermediate layer 2, that is, the two intermediate layers were provident

(Performance Evaluation)

Printing was performed 300000 times, using bizhub PRO C6501 (manufactured by Konica Minolta Business Technologies, Inc., a tandem color complex machine of laser exposure, reversal development, and intermediate transfer body) mounted with an electrophotographic photoreceptor of the Examples 1 to 3 and the Comparative Examples 1 to 3. The surface potential and an image (density unevenness and fog) before and after long-term printing (first printing and after 300000-th printing) were evaluated as follows. Those evaluation results are shown, in the following Tables 2-1 and 2-2.

<Surface Potential of Electrophotographic Photoreceptor>

For the surface of the obtained electrophotographic photoreceptor, a difference (potential variation ΔVi ) between an initial potential (after 0 second) at 10° C. under 15% RH and a potential after a lapse of 30 seconds was measured by an electrical characteristic measuring apparatus. A variation of the surface potential was measured by repeating charging and exposure under conditions that a grid voltage was −800 V and an exposure amount was 0.5 μJ/cm², while the electrophotographic photoreceptor was rotated at 150 rpm., ΔVi was evaluated under the following criteria.
A: Not more than 20 V both before and after long-term printing
B: Not more than 20 V before long-term printing, more than 20 V and not more than 30 V after long-term printing
C: More than 20 V and not more than 30 V before long-term printing, or, not more than 20 V before long-term printing and more than 30 V after long-term printing (NG)
D: More than 30 V before long-term printing (NG)

<Evaluation of Image>

An image was formed at 30° C. under 80% RH using bizhub PRO C6501 (manufactured by Konica Minolta Business Technologies, Inc., a tandem color complex machine of laser exposure, reversal development, and intermediate transfer body), and evaluated.

1) Density Unevenness

An obtained electrophotographic photoreceptor was located at a position of black (BK). Then, a transfer current was changed from 20 μA to 100 μa, and the chart shown in FIG. 4 was output. In FIG. 4, D represents a rotation axis direction of the electrophotographic photoreceptor. An image formed on a transfer material “POD gloss coat (A3 size, 100 g/m²)” (produced by Oji Paper Co., Ltd.) was visually observed. The density unevenness of the image was evaluated under the following criteria.
A: Even if the transfer current is not less than 60 μA, no density unevenness is observed.
B: Although density unevenness is slightly observed at the transfer current of not less than 60 μA, it does not. a problem for practical use.
C: Although density unevenness is slightly observed at the transfer current of 40 to 50 μA, it does not a problem for practical use (the level is a problem when a high-quality image is formed).
D: Density unevenness is clearly observed at the transfer current of less than 40 μA, and the level is a problem for practical use.

2) Fog (Sensory Evaluation)

An obtained electrophotographic photoreceptor was located at a position of black (BK). A “POD gloss coat (A3 size, 100 g/m²)” (produced by Oji Paper Co., Ltd.) with no image was provided to be conveyed to the position of black, and, thus, to form a solid color image (white solid image) under conditions such that the grid voltage was −800 V and a developing bias was −650 V. Then, the presence of fog on the obtained transfer material was evaluated. Similarly, a yellow solid image was formed under conditions that the grid voltage was −800 V and a developing bias was −650 V. Then, the presence of fog on the obtained transfer material was evaluated. The presence of fog was evaluated under the following criteria.
A: No fog
B: Although fog is slightly observed when the image is enlarged, it does not a problem for practical use.
C: Fog is slightly observed by visual check, and it is a problem for practical use (NG).
D: Fog is noticeable (NG).

3) Fog (Density Evaluation)

In the item 2), for the transfer material after forming the solid color image, the fog density at a portion without the image of the material was measured by a Macbeth density meter “RD-918” (manufactured by Macbeth Co., Ltd.). More specifically, the fog density was measured by the following procedure.

(a) Absolute image densities at arbitrary 20 portions of a transfer material (blank paper) formed with no image were measured, and the average value of them was determined as “blank paper density before image formation”.

(b) Each obtained electrophotographic photoreceptor was mounted in an image forming unit of black (BK), and a solid color image was formed on the transfer material of the above item 2). The absolute image densities at arbitrary 20 portions of the obtained transfer material were measured, and the average value of them was determined as “blank paper density after formation of a solid color image”.

(c) The fog density was obtained, based on the following formula (B) by using the blank paper densitys obtained in the above items (a) and (b).

fog density=(blank paper density after solid color image formation)−(blank paper density before image formation) Formula (B)

The fog density was evaluated under the following criteria.
A: The fog density is not more than 0.003 and is good.
B: The fog density is more than 0.003 and not more than 0.006 and is good.
C: The fog density is more than 0.006 and not more than 0.01, and the level is a problem for practical use when high quality is required.
D: The fog density is sore than 0.01, and the level is a problem for practical use.

TABLE 2-1

| | | Intermediate layer | | | | | |
|---|---|---|---|---|---|---|---|
| | | Surface-treated metal oxide particle | | | | | |
| | | First metal oxide | | Second metal | | | Position where |
| | | particle | | oxide particle | | | first metal oxide |
| | | | Added amount | | Added amount | Vₐ/V₁ or | particles are |
| | Photoreceptor | | (parts by | | (parts by | V_{b}/V₁ or | unevenly |
| | No. | Particle No. | mass) | Particle No. | mass) | V_{c}/V₁ | distributed |
| Example 1 | 1 | 6 | 130 | 1 | 150 | 0.57 | c layer (substrate |
| | | | | | | | side) |
| Example 2 | 2 | 2 | 120 | 7 | 165 | 0.70 | c layer (substrate |
| | | | | | | | side) |
| Example 3 | 3 | 8 | 135 | 3 | 145 | 0.73 | a layer |
| | | | | | | | (photosensitive |
| | | | | | | | layer side) |
| Example 4 | 4 | 4 | 160 | 9 | 190 | 0.55 | a layer |
| | | | | | | | (photosensitive |
| | | | | | | | layer side) |
| Example 5 | 5 | 5 | 140 | 9 | 185 | 0.63 | a layer |
| | | | | | | | (photosensitive |
| | | | | | | | layer side) |
| Example 6 | 6 | 10 | 100 | 7 | 205 | 0.66 | c layer (substrate |
| | | | | | | | side) |
| Example 7 | 7 | 11 | 180 | 12 | 280 | 0.60 | c layer (substrate |
| | | | | | | | side) |
| Example 8 | 8 | 2 | 120 | 7 | 165 | 0.70 | c layer (substrate |
| | | | | | | | side) |

| | Characteristics of electrophotographic photoreceptor | | | | | | | | |
|---|---|---|---|---|---|---|---|---|---|
| | | Image evaluation | | | | | | | |
| | | Density | | Fog | | | | | |
| | | unevenness | | White | | Y | | Density | |
| | Potential | Before | After | Before | After | Before | After | Before | After |
| | measurement | long-term | long-term | long-term | long-term | long-term | long-term | long-term | long-term |
| | ΔVI (V) | printing | printing | printing | printing | printing | printing | printing | printing |
| Example 1 | A | A | B | A | A | A | B | A | B |
| Example 2 | A | A | A | A | A | A | B | A | A |
| Example 3 | B | A | B | A | A | A | A | A | A |
| Example 4 | B | A | B | A | A | A | A | A | A |
| Example 5 | A | A | B | A | A | A | A | A | A |
| Example 6 | A | A | A | A | A | A | B | A | B |
| Example 7 | B | A | B | A | B | A | B | A | B |
| Example 8 | A | A | A | A | A | A | B | A | A |

TABLE 2-2

| | | Intermediate layer | | | | | |
|---|---|---|---|---|---|---|---|
| | | Surface-treated metal oxide particle | | | | | |
| | | First metal oxide | | Second metal oxide | | | |
| | | particle | | particle | | | |
| | | | Added amount | | Added amount | Vₐ/V₁ or | Position where first |
| | Photoreceptor | Particle | (parts by | Particle | (parts by | V_{b}/V₁ or | metal oxide particles are |
| | No | No. | mass) | No. | mass) | V_{c}/V₁ | unevenly distributed |
| [symbol] omparative | 9 | 2 | 120 | 9 | 165 | 0.33 | Nothing |
| Example 1 | | | | | | | |
| [symbol] omparative | 10 | 5 | 150 | 7 | 200 | 0.33 | Nothing |
| Example 2 | | | | | | | |
| [symbol] omparative | 11 | TiO₂ | 500 | SnO₂ | 500 | Two layers | (Photosensitive |
| Example 3 | | | | | | | layer side) |

Characteristics of electrophotographic photoreceptor

| Image evaluation | | | |
|---|---|---|---|
| Density | Fog | | |
| unevenness | White | Y | Density |

| | Potential | Before | After | Before | After | Before | After | Before | After |
|---|---|---|---|---|---|---|---|---|---|
| | measurement | long-term | long-term | long-term | long-term | long-term | long-term | long-term | long-term |
| | ΔVI (V) | printing | printing | printing | printing | printing | printing | printing | printing |
| [symbol] omparative | C | C | D | C | D | D | D | C | D |
| Example 1 | | | | | | | | | |
| [symbol] omparative | C | C | C | C | D | D | D | D | D |
| Example 2 | | | | | | | | | |
| [symbol] omparative | D | C | D | B | B | B | C | B | C |
| Example 3 | | | | | | | | | |

[symbol]

indicates data missing or illegible when filed

As shown in Table 2, the electrophotographic photoreceptors of Examples 1 to 8 in which the first metal oxide particles contained in the intermediate layer were unevenly distributed in the intermediate layer, showed low ΔVi of the surface potential of not more than 20 V before long-term printing and also low ΔVi of not more than 30 V after long-term printing. At the same time, it was confirmed that the occurrence of both the density unevenness and the fog could be suppressed. Meanwhile, he Comparative Example 1 in which the first metal oxide particles contained in the intermediate layer were not unevenly distributed, it was confirmed that both of the density unevenness and the fog could not be suppressed. In the Comparative Example 2, the first and second metal oxide particles, which had different particle sizes and was surface treated with the same surface treatment agent, were used, then, the first metal oxide particles were not unevenly distributed. Therefore, it is understood that the effect of enhancement of the electron-transporting properties and enhancement of the blocking properties against irregular electrons could not be obtained, and the results of the image evaluation were inferior to the results of the Examples. In the Comparative Example 3 in which the two intermediate layers were formed, the results of the potential measurement and the density unevenness were consequently not overcome. It is understood that this is because an interface of resin existed in the intermediate layer then the electron-transporting properties were deteriorated.

What is claimed is:

1. An electrophotographic photoreceptor comprising an intermediate layer being a single layer,
wherein said intermediate layer contains first metal oxide particles, second metal oxide particles having higher electron-transporting properties than those of the first metal oxide particle and a binder resin, and
the first metal oxide particles are unevenly distributed in a thickness direction of the intermediate layer.

2. An electrophotographic photoreceptor according to claim 1, wherein, the first metal oxide particles are unevenly distributed in a thickness direction of the intermediate layer so as to satisfy the following relationship:
Vₐ/V₁≧0.5,
V_{b}/V₁≧0.5,
or
V_{c}/V₁≧0.5,
wherein, when a cross section of the intermediate layer is equally divided into three layers in a thickness direction, V₁ is a total volume of the first metal oxide particles in the intermediate layer, Vₐ is a volume of the first metal oxide particles in a outermost layer of the divided intermediate layers, V_{b} is a volume of the first metal oxide particles in a middle layer of the divided intermediate layers, and V_{c} is an innermost layer of the divided intermediate layers.

3. An electrophotographic photoreceptor according to claim 2, wherein, V₁, Vₐ, V_{b} and V_{c} satisfy the following relationship:
0.9≧Vₐ/V₁≧0.6,
0.9≧V_{b}/V₁≧0.6,
or
0.9≧V_{c}/V₁≧0.6.

4. An electrophotographic photoreceptor according to claim 1, wherein, a volume ratio of the first metal oxide particles and the second metal oxide particles is 6:4 to 3:7.

5. An electrophotographic photoreceptor according to claim 1, wherein, number average primary particle sizes of the first metal oxide particles and the second, metal oxide particles are 1 to 100 nm.

6. An electrophotographic photoreceptor according to claim 5, wherein, the number average primary particle sizes of the first metal oxide particles and the second metal oxide particles are 5 to 95 nm.

7. An electrophotographic photoreceptor according to claim 1, wherein, at least the first metal oxide particles are titanium oxide particles.

8. An electrophotographic photoreceptor according to claim 7, wherein, the first metal oxide particles and the second metal oxide particles are titanium oxide particles.

9. An electrophotographic photoreceptor according to claim 1, wherein, at least one of the first metal oxide particle and the second metal oxide particle was surface treated by at least one of an inorganic compound, a reactive organic silicone compound and an organic titanium compound.

10. An electrophotographic photoreceptor according to claim 9, wherein, the inorganic compound is alumina, silica, or a combination of alumina and silica.

11. An electrophotographic photoreceptor according to claim 9, wherein, the reactive organic silicone compound is at least one of 3-methacryloxypropyl trimethoxy silane, 3-acryloxypropyl trimethoxysilane, and methyl hydrogen polysiloxane.

12. An electrophotographic photoreceptor according to claim 1, wherein, the organic titanium compound is at least one of titanium acylate, titanium chelate.

13. An electrophotographic photoreceptor according to claim 1, wherein, the binder resin is polyamide resin.

14. An electrophotographic photoreceptor according to claim 13, wherein, the polyamide resin is alcohol-soluble polyamide resin.

15. An electrophotographic photoreceptor according to claim 1, wherein, a film thickness of the intermediate layer is 0.5 to 15 μm.

16. An electrophotographic photoreceptor according to claim 16, wherein, the film thickness of the intermediate layer is 1 to 7 μm.
